(19) United States
(12) Patent Application Publication
(10) Pub. No.: US 2026/0046583 A1
(43) Pub. Date: Feb. 12, 2026

(54) ADJUSTMENT METHOD OF AUDIO SIGNAL AND COMPUTING APPARATUS FOR AUDIO SIGNAL ADJUSTMENT

(71) Applicant: Acer Incorporated, New Taipei City (TW)

(72) Inventors: Po-Jen Tu, New Taipei City (TW); Jia-Ren Chang, New Taipei City (TW); Kai-Meng Tzeng, New Taipei City (TW)

(73) Assignee: Acer Incorporated, New Taipei City (TW)

(21) Appl. No.: 19/236,937

(22) Filed: Jun. 12, 2025

(30) Foreign Application Priority Data
Aug. 8, 2024 (TW) 113129754

(51) Int. Cl. H04S 7/00; H04S 1/00

(52) U.S. Cl. CPC H04S 7/301; H04S 1/007; H04S 7/307

(57) ABSTRACT

An adjustment method of an audio signal and a computing apparatus for audio signal adjustment are disclosed. Current attitude data of a current time interval is measured. Data to be evaluated is determined based on an angle error between the current attitude data and previously predicted data. By inputting the data to be evaluated into a prediction model, future predicted data of a future time interval is generated. Audio characteristics of an audio signal are adjusted to a predicted rotation angle corresponding to the future time interval. Therefore, the listening experience can be improved.

### CROSS-REFERENCE TO RELATED APPLICATION

This application claims the priority benefit of Taiwan application serial no. 113129754, filed on Aug. 8, 2024. The entirety of the above-mentioned patent application is hereby incorporated by reference herein and made a part of this specification.

### BACKGROUND

### Technical Field

The disclosure relates to audio signal processing, and particularly relates to an adjustment method of an audio signal and a computing apparatus for audio signal adjustment.

### Description of Related Art

Spatial audio effects transfer audio signals to a surround sound field formed by multiple virtual speakers, the response and delay of virtual audio signals from different directions are adjusted, and the audio signals are accordingly transferred into a three-dimensional sound field. It is worth noting that in practical applications, the head of the user may rotate, causing current spatial audio effects to encounter transmission delay problems, and the delay time may be as high as 204 milliseconds or more.

### SUMMARY

The disclosure provides an adjustment method of an audio signal and a computing apparatus for audio signal adjustment, which can reduce the time delay caused by head rotation.

The adjustment method of the audio signal in an embodiment of the disclosure includes (but is not limited to) the following steps: measuring current attitude data of a current time interval, wherein the current attitude data comprises a measured rotation angle of a target portion in the current time interval; determining data to be evaluated based on an angle error between the current attitude data and previously predicted data, wherein the previously predicted data comprises a predicted rotation angle of the target portion in the current time interval predicted in a previous time interval, the angle error is an error between the measured rotation angle and the predicted rotation angle, a comparison result of the angle error with an error threshold is used to select attitude data of at least one of a plurality of time intervals to the data to be evaluated, the closer the comparison result corresponds to selecting the attitude data from more of the time intervals, the farther the comparison result corresponds to selecting the attitude data from less of the time intervals, and the attitude data of the time intervals comprises the measured rotation angle of the target portion in the time intervals and a change in the measured rotation angle; generating a future predicted data of a future time interval by inputting the data to be evaluated into a prediction model, wherein the prediction model is trained through a machine learning algorithm and learns attitude changes of the target portion, the future predicted data comprises the predicted rotation angle of the target portion in the future time interval predicted in the current time interval, and the previously predicted data is predicted data corresponding to the current time interval predicted by the prediction model; and adjusting an audio characteristic of an audio signal to the predicted rotation angle corresponding to the future time interval, wherein the audio characteristic is related to at least one of amplitude and phase of the audio signal.

The computing apparatus for audio signal adjustment in an embodiment of the disclosure includes (but is not limited to) a storage device and a processor. The storage device is used to store a program code. The processor is coupled to the storage device. The processor is configured to load the program code to perform: measuring current attitude data of a current time interval, wherein the current attitude data comprises a measured rotation angle of a target portion in the current time interval; determining data to be evaluated based on an angle error between the current attitude data and previously predicted data, wherein the previously predicted data comprises a predicted rotation angle of the target portion in the current time interval predicted in a previous time interval, the angle error is an error between the measured rotation angle and the predicted rotation angle, a comparison result of the angle error with an error threshold is used to select attitude data of at least one of a plurality of time intervals to the data to be evaluated, the closer the comparison result corresponds to selecting the attitude data from more of the time intervals, the farther the comparison result corresponds to selecting the attitude data from less of the time intervals, and the attitude data of the time intervals comprises the measured rotation angle of the target portion in the time intervals and a change in the measured rotation angle; generating a future predicted data of a future time interval by inputting the data to be evaluated into a prediction model, wherein the prediction model is trained through a machine learning algorithm and learns attitude changes of the target portion, the future predicted data comprises the predicted rotation angle of the target portion in the future time interval predicted in the current time interval, and the previously predicted data is predicted data corresponding to the current time interval predicted by the prediction model; and adjusting an audio characteristic of an audio signal to the predicted rotation angle corresponding to the future time interval, wherein the audio characteristic is related to at least one of amplitude and phase of the audio signal.

Based on the above, the adjustment method of the audio signal and the computing apparatus for audio signal adjustment according to an embodiment of the disclosure compare the error in rotation angle between the current measured attitude data and the attitude data of the current time interval predicted in the previous time interval, select attitude data of one or more time intervals to the data to be evaluated, determine the attitude data in the future time interval corresponding to the data to be evaluated through the prediction model, and accordingly adjust the audio characteristics of the audio signal. In this way, the rotation angle of the next time interval can be determined in advance and the output delay of the audio player can be reduced.

In order to make the above-mentioned features and advantages of the disclosure more comprehensible, embodiments are given below and described in detail with reference to the accompanying drawings.

### BRIEF DESCRIPTION OF THE DRAWINGS

FIG. 1A is a block diagram of components of a system according to an embodiment of the disclosure.

FIG. 1B is a schematic diagram illustrating an application scenario according to an embodiment of the disclosure.

FIG. 2 is a flow chart of an adjustment method of an audio signal according to an embodiment of the disclosure.

FIG. 3 is a schematic diagram illustrating an attitude according to an embodiment of the disclosure.

FIG. 4 is a flow chart of an identification method of a rotation angle according to an embodiment of the disclosure.

FIG. 5 is a flow chart for determining data to be evaluated according to an embodiment of the disclosure.

FIG. 6 is a schematic diagram of a combination of a convolutional neural network (CNN) and a long short-term memory (LSTM) network according to an embodiment of the disclosure.

FIG. 7 is a schematic diagram of training samples according to an embodiment of the disclosure.

### DESCRIPTION OF THE EMBODIMENTS

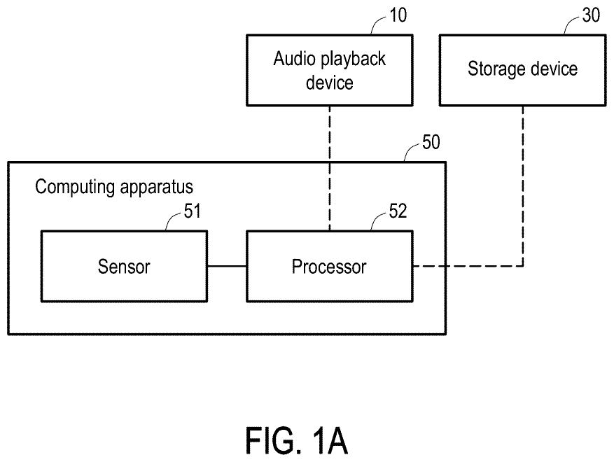

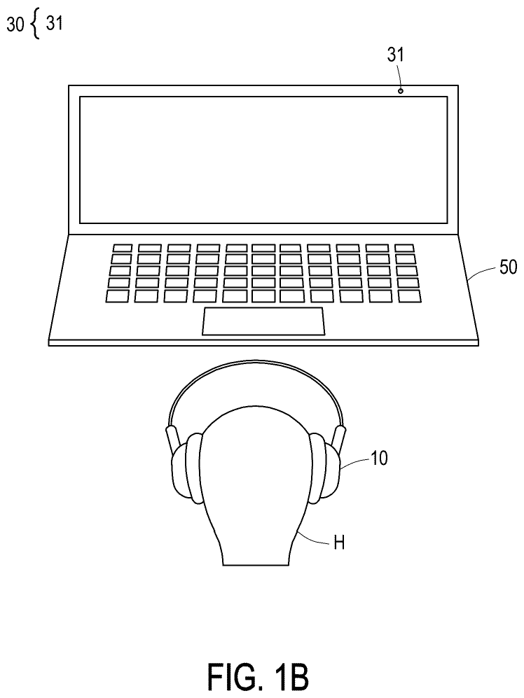

FIG. 1A is a block diagram of components of a system according to an embodiment of the disclosure. Referring to FIG. 1A, the system includes an audio playback device 10, a sensor 30, and a computing apparatus 50.

The audio playback device 10 may be a headset or a wearable playback device. FIG. 1B is a schematic diagram illustrating an application scenario according to an embodiment of the disclosure. Referring to FIG. 1B, the audio playback device 10 may be worn on a head H of a user. Speaker units (in-ear or canal) of the audio playback device 10 may be oriented toward the ears on the head H. In an embodiment, the audio playback device 10 is used to play audio signals.

The sensor 30 may be a camera, a video camera, or a circuit or device with an image capturing function. Referring to FIG. 1B, the sensor 30 is a built-in or external image capturing device 31. The lens of the image capturing device 31 may face the head H. In an embodiment, the image capturing device 31 is used to capture images. Taking FIG. 1B as an example, the image capturing device 31 captures the head and generates a head image accordingly (that is, captures the image of the head H). Alternatively, the sensor 30 may be an accelerometer, a gyroscope, an inertial sensor, or a component, circuit or device with a motion detection function. In an embodiment, the sensor 30 is used to obtain motion sensing data. For example, motion sensing data related to velocity, angular velocity, acceleration, and/or orientation.

The computing apparatus 50 may be a smartphone, a tablet computer, a desktop computer, a laptop computer, a smart assistant device, a wearable device, a smart TV, or other electronic devices. The computing apparatus 50 is communicatively connected to the audio playback device 10 and the sensor 30. For example, the computing apparatus 50 is equipped with USB, UART, or other wired transmission interfaces (not shown), or equipped with Wi-Fi, Bluetooth, or other wireless communication transceiver circuits (not shown), and transmits or receives signals accordingly. For example, the sensor 30 transmits a signal carrying an image to the computing apparatus 50, or the computing apparatus 50 transmits an audio signal to the audio playback device 10.

The computing apparatus 50 includes (but is not limited to) a storage device 51 and a processor 52.

The storage device 51 may be any type of fixed or removable random access memory (RAM), read only memory (ROM), flash memory, hard disk drive (HDD), solid-state drive (SSD), or similar components. In an embodiment, the storage device 51 is used to store program codes, software modules, configurations, data (for example, the audio signal, the head image, or algorithm parameters), or files, and the embodiments will be described in detail later.

The processor 52 is coupled to the storage device 51. The processor 52 may be a central processing unit (CPU), a graphics processing unit (GPU), or other programmable general-purpose or special-purpose microprocessor, a digital signal processor (DSP), a programmable controller, a field programmable gate array (FPGA), an application-specific integrated circuit (ASIC), a neural network accelerator, or other similar components, or a combination of the above components. In an embodiment, the processor 52 is used to execute all or part of the operations of the computing apparatus 50, and may load and execute each program code, software module, file, and data stored in the storage device 51. In an embodiment, the processor 52 may control the image capturing device 31 to capture or obtain the sensing data from the sensor 30. In another embodiment, the processor 52 may control the playback function of the audio playback device 10 (for example, play, pause, switch tracks, fast forward, or reverse). In some embodiments, the functions of the processor 52 may be implemented through software or a chip.

Regarding the application scenario, taking FIG. 1B as an example, the computing apparatus 50 is a laptop computer, and the head H faces the display of the laptop computer. However, there may be other changes in the position and/or orientation of the user.

In the following, the method according to the embodiments of the disclosure will be described with reference to each component and module in the audio playback device 10, the sensor 30, and the computing apparatus 50. Each process of the method may be adjusted according to the implementation situation, and is not limited thereto.

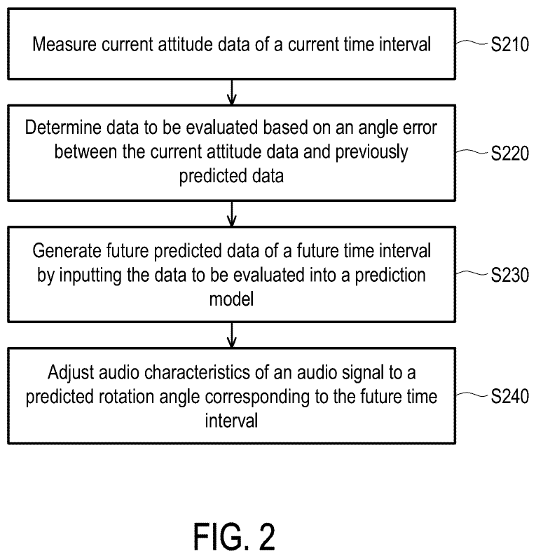

FIG. 2 is a flow chart of an adjustment method of an audio signal according to an embodiment of the disclosure. Referring to FIG. 2, the processor 52 measures current attitude data of a current time interval (Step S210). Specifically, the current time interval is a time interval corresponding to a current time point. The time interval in this description is, for example, 15, 30, or 60 milliseconds, which is 7.5, 15, or 30 milliseconds before and after the current time point, but the length thereof may still be adjusted according to actual needs. The current attitude data includes a measured rotation angle of a target portion in the current time interval. The target portion may be the head, the ears, or other parts. In an embodiment, the head is used to wear the audio playback device 10. As shown in FIG. 1B, the head H wears over-ear headphones (that is, an example of the audio playback device 10). Rotations of the head H cause attitude changes. The attitude changes include a rotation angle of the head rotating from a first orientation to a second orientation. For example, the head at a time point t is toward the first orientation, and the head at a time point t+1 is toward the second orientation.

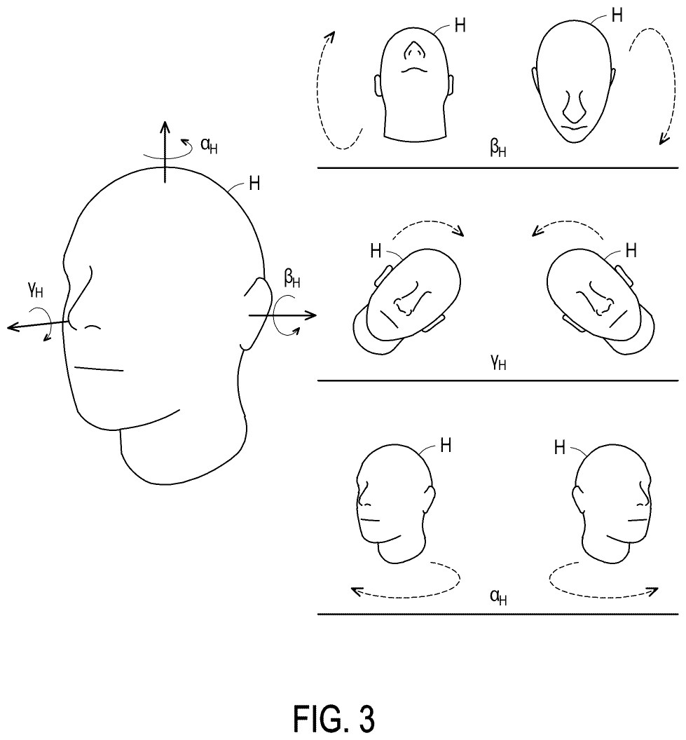

FIG. 3 is a schematic diagram illustrating an attitude according to an embodiment of the disclosure. Referring to FIG. 3, the rotation angles of the head H include yaw α_{H}, pitch β_{H}, and roll γ_{H} corresponding to three axial directions.

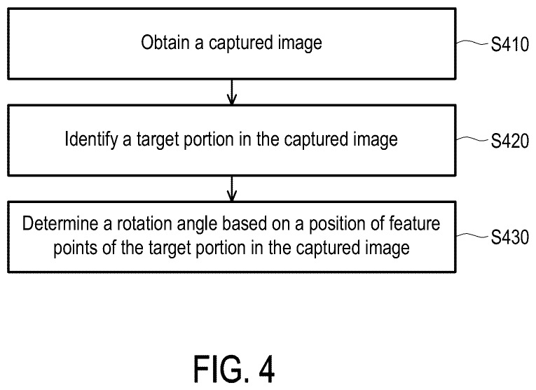

In an embodiment, the processor 52 may identify the attitude change of the target portion based on a captured image. FIG. 4 is a flow chart of an identification method of a rotation angle according to an embodiment of the disclosure. Referring to FIG. 4, the processor 52 may obtain the captured image through the image capturing device 31 (Step S410). As shown in FIG. 1B, the head H is located in front of the image capturing device 31, and the lens field of view of the image capturing device 31 covers the head H. The image features of the captured image may be used to identify the attitude change. The image features are, for example, histogram of oriented gradient (HOG), scale-invariant feature transform (SIFT), Harr, or speeded up robust features (SURF). The image features may also be feature maps captured through machine learning models.

The captured image is an image captured of the head rotating from the first orientation to the second orientation. The image capturing device 31 may continuously capture the head images. The frequency of capturing images may be 24, 60, or 120 images per second, and is not limited thereto. The image capturing device 31 may also trigger the image capturing function based on predetermined conditions (for example, a user operation or a sound).

The processor 52 may identify the target portion (for example, the head or face) in the captured image (Step S420). The identification may be based on object detection technology. For example, the processor 52 may apply neural network-based algorithms (for example, YOLO (you only look once), region based convolutional neural networks (R-CNN, or fast R-CNN (Fast CNN)), or feature matching-based algorithms (for example, histogram of oriented gradient (HOG), scale invariant feature transform (SIFT), Harr, or feature comparison of speeded-up robust features (SURF)) to implement object detection.

The processor 52 may also identify organs in the captured image (for example, eyes, mouth, or nose). It should be noted that when the lens of the image capturing device 31 is fixed, when capturing the image of the head, in some attitudes, it is possible that some facial organs may not be captured.

The processor 52 may define feature points for the captured image. For example, the feature point is located at the corner of the mouth, the tip of the nose, the upper edge of the ear, or the eye, but is not limited thereto.

The processor 52 may determine a rotation angle according to a position of the feature point of the target portion in the captured image (Step S430). The processor 52 may track the position of one or more feature points in multiple consecutive captured images. Changes in the attitude of the target portion (for example, the head) are reflected in changes in the positions of the feature points. For example,

$${α}_{H} = ar tan ( \frac{{RP}_{L - eye - y} - {RP}_{R - eye - y}}{{RP}_{L - eye - x} - {RP}_{R - eye - x}} ) \qquad ( 1 )$$

$${β}_{H} = {RP}_{nose - x}^{′} - {RP}_{nose - x} \qquad ( 2 )$$

$${γ}_{H} = {RP}_{nose - y} - {RP}_{nose - y}^{′} \qquad ( 3 )$$

RP_{L-eye-y} is the position of the left eye feature point on the vertical axis in the captured image, RP_{R-eye-y} is the position of the right eye feature point on the vertical axis in the captured image, RP_{L-eye-x} is the position of the left eye feature point on the horizontal axis in the captured image, RP_{R-eye-x} is the position of the right eye feature point on the horizontal axis in the captured image,

$${RP}_{nose - x}^{′}$$

is the position of the nose feature point on the horizontal axis in the captured image when the head is in the second orientation, RPₙₒₛₑ₋ₓ is the position of the nose feature point on the horizontal axis in the captured image when the head is in the first orientation,

$${RP}_{nose - y}^{′}$$

is the position of the nose feature point on the vertical axis in the captured image when the head is in the second orientation, and RP_{nose-y} is the position of the nose feature point on the vertical axis in the captured image when the head is in the first orientation.

In other embodiments, the processor 52 may also apply neural network-based algorithms (for example, YOLO, region-based convolutional neural networks (R-CNN), or fast R-CNN (Fast CNN)) or feature matching-based algorithms (for example, histogram of oriented gradient (HOG), scale invariant feature transform (SIFT), Harr, or feature comparison of speeded-up robust features (SURF)) to implement attitude identification. For example, the neural network is trained to learn the association between multiple reference attitudes/rotation angles and image features. For another example, a lookup table records the association between multiple reference attitudes/rotation angles and image features. For another example, a transformation function records the association between multiple reference attitudes/rotation angles and image features.

In another embodiment, the sensor 30 is a motion sensor (for example, a gyroscope, an accelerometer, or an inertial measurement unit). The sensing data of the motion sensor may be used to analyze attitude changes.

Referring to FIG. 2, the processor 52 determines data to be evaluated based on an angle error between the current attitude data and previously predicted data (Step S220). Specifically, the previously predicted data includes a predicted rotation angle of the target portion in the current time interval predicted in a previous time interval. The previous time interval is a time interval earlier than the current time interval, for example, earlier than 20, 30, or 50 milliseconds, but not limited thereto. In a certain previous time interval, the processor 52 may predict predicted data (for example, predicting the rotation angle of the target portion in the current time interval) corresponding to the current time interval (that is, a future time interval relative to the previous time interval, and the future time interval is later than the previous time interval) based on the attitude data of one or more previous time intervals. The generation of the predicted data will be described in detail later.

An angle error is an error between the measured rotation angle and the predicted rotation angle. For example, the error between the measured yaw α_{H}, pitch β_{H}, and roll γ_{H} of the current time interval and the predicted yaw α_{H}, pitch β_{H}, and roll γ_{H} of the current time interval, and the root mean square or other statistical value of the error of the three-axis rotation angle (that is, yaw α_{H}, pitch β_{H}, and roll γ_{H}) may be taken as the representative of the angle error. The error may be calculated by subtracting the values of the measured rotation angle and the predicted rotation angle. For example, the mathematical expression corresponding to a current time interval n is:

$${E}_{θ} ( n ) = ( n ) - {θ}_{H} ( n ) \qquad ( 4 )$$

E_{θ}(n) is the error (that is, the above-mentioned angle error) between the angle measured in the current time interval and the estimated rotation angle of the previous time interval (that is, the previous time interval that is one time interval apart from the current time interval), θ_{H}(n) is the measured rotation angle in the measured attitude data of the current time interval n, and [symbol] (n) is the predicted rotation angle in the previously predicted data for the current time interval n. Similarly, the mathematical expression corresponding to a previous time interval n−1 (one time interval apart from the current time interval) is E_{θ}(n−1)= [symbol] (n−1)−θ_{H}(n−1), in which Ee (n−1) is the error (that is, the above-mentioned angle error) between the angle measured in the previous time interval and the estimated rotation angle of a further previous time interval (that is, a previous time interval that is one time interval apart from the previous time interval n−1), θ_{H}(n−1) is the measured rotation angle in the measured attitude data of the previous time interval n−1, and [symbol] (n−1) is the predicted rotation angle in the previously predicted data for the previous time interval n−1. The mathematical expressions of the angle error corresponding to other time intervals may be deduced in the same way, so details will not be repeated here.

The comparison result of the angle error with the error threshold is used to select the attitude data of at least one of multiple time intervals to the data be evaluated. The closer the comparison result corresponds to selecting attitude data from more time intervals. That is, if the comparison result is that the smaller the angle error or the closer the current attitude data is to the previously predicted data (for example, the distance in the feature coordinate system is closer), then the attitude data of more time intervals is selected. The multiple time intervals include the current time interval, the previous time interval that is one time interval apart from the current time interval, the previous time interval that is two time intervals apart from the current time interval, . . . , and the previous time interval that is N time intervals apart from the current time interval. N is a positive integer greater than zero. N is, for example, 9, 10, or 15, and may be related to the length of the time interval, but is not limited thereto.

On the other hand, the farther the comparison result corresponds to selecting attitude data from less time intervals. That is, if the comparison result is that the larger the angle error or the farther the current attitude data is from the previously predicted data (for example, the distance in the feature coordinate system is farther), then the attitude data of less time intervals is selected.

The current time interval and each previous time interval include respective attitude data. That is to say, if attitude data of more time intervals is selected to the data to be evaluated, then the quantity of time intervals corresponding to the attitude data included in the data to be evaluated is greater. If attitude data of less time intervals is selected to the data to be evaluated, then the quantity of time intervals corresponding to the attitude data included in the data to be evaluated is less.

The attitude data of each of the multiple time intervals includes the measured rotation angle of the target portion in the time interval and the change of the measured rotation angle. The determination of the measured rotation angle may refer to the description of Step S210, so details will not be repeated here. The change of the measured rotation angle may be the difference in the measured rotation angles between adjacent time intervals (for example, the difference may be obtained by subtracting the values of the two measured rotation angles). For example, the mathematical expression of the difference in the measured rotation angles corresponding to the current time interval n is:

$${Δθ}_{H} ( n ) = {θ}_{H} ( n ) - {θ}_{H} ( n - 1 ) \qquad ( 5 )$$

Δθ_{H}(n) is the difference in the measured rotation angles between the current time interval n and the previous time interval n−1 (one time interval apart from the current time interval), θ_{H}(n) is the same as the measured rotation angle in the measured attitude data of the current time interval n defined by the equation (4), and PH (n−1) is the measured rotation angle in the measured attitude data of the previous time interval n−1. Similarly, the mathematical expression corresponding to the previous time interval n−1 is Δθ_{H}(n−1)=θ_{H}(n−1)−θ_{H}(n−2), in which θ_{H}(n−2) is the measured rotation angle in the measured attitude data of the previous time interval n−2 (two time intervals apart from the current time interval n, and one time interval apart from the previous time interval n−1). The mathematical expressions for measuring the difference in rotation angles corresponding to remaining time intervals may be deduced in the same way, so details will not be repeated here.

The change in the measured rotation angle may also be the difference between the differences in the measured rotation angles of the above-mentioned adjacent time intervals (that is, the change in the difference, for example, the value may be obtained by subtracting the two difference values). For example, the mathematical expression corresponding to the current time interval n is:

$${Δ}^{2} {θ}_{H} ( n ) = {Δθ}_{H} ( n ) - {Δθ}_{H} ( n - 1 ) \qquad ( 6 )$$

Δ²θ_{H}(n) is the difference between the measured rotation angle difference between the adjacent current time interval n and the previous time interval n−1 (one time interval apart from the current time interval), Δθ_{H}(n) is the same as the difference in the measured rotation angles between the current time interval n and the previous time interval n−1 defined by the equation (2), and Δθ_{H}(n−1) is the difference in the measured rotation angles between the previous time interval n−1 and another previous time interval n−2 (two time intervals apart from the current time interval n, and one time interval apart from the previous time interval n−1). Similarly, the mathematical expression corresponding to the previous time interval n−1 is Δ²θ_{H}(n−1)=40H (n−1)−Δθ_{H}(n−2), in which 420H (n−1) is the difference between the measured rotation angle difference between the adjacent previous time interval n−1 and the previous time interval n−2, and Δθ_{H}(n−2) is the difference between the measured rotation angle of the previous time interval n−2 and another previous time interval n−3 (three time intervals apart from the current time interval n, two time intervals apart from the previous time interval n−1, and one time interval apart from the previous time interval n−2). The mathematical expressions of the differences (that is, changes in differences) between the measured rotation angle differences corresponding to remaining time intervals may be deduced in the same way, so details will not be repeated here.

Alternatively, the change in the measured rotation angle may be a combination of the above differences (for example, a combination of the measured rotation angle corresponding to the current time interval n and the change thereof [Δθ_{H}(n),Δ²θ_{H}(n)]). At this time, the attitude data of each time interval is the combination of the measured rotation angle of the current time interval and the above differences (for example, the combination of the measured rotation angle corresponding to the current time interval n and the change thereof [θ_{H}(n),Δθ_{H}(n),Δ²θ_{H}(n)], the combination of the measured rotation angle corresponding to the previous time interval n−1 and the change thereof [θ_{H}(n−1),Δθ_{H}(n−1),Δ²θ_{H}(n−1)], and so on).

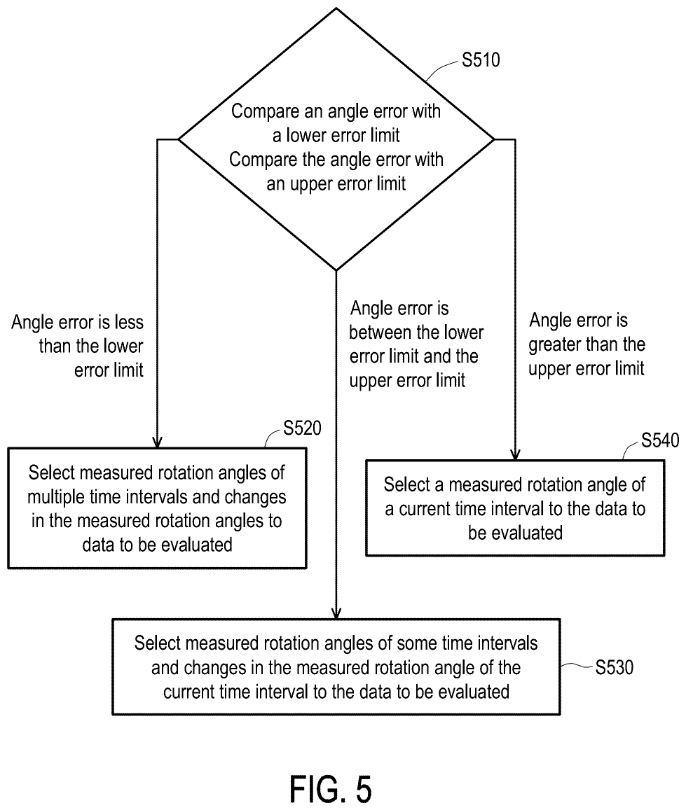

FIG. 5 is a flow chart for determining data to be evaluated according to an embodiment of the disclosure. Referring to FIG. 5, error thresholds used for comparison with angle error include an upper error limit and/or a lower error limit. The processor 52 may compare the angle error with the lower error limit and/or compare the angle error with the upper error limit (Step S510). The upper error limit is, for example, 15, 20, or 25 degrees, and the lower error limit is, for example, 8, 10, or 12, but is not limited thereto.

In response to the angle error between the current attitude data and the previously predicted data being less than the lower error limit, the processor 52 may select the measured rotation angle of all of the multiple time intervals and the change in the measured rotation angle to the data to be evaluated (Step S520). Specifically, the processor 52 may define the length of the time window, and the length is the quantity of the time intervals. For example, if the length of the time window is 10, then ten time intervals are included. That is, the multiple time intervals include the current time interval, the previous time interval that is one time interval apart from the current time interval, the previous time interval that is two time intervals apart from the current time interval, . . . , and the previous time interval that is 9 time intervals apart from the current time interval.

In addition, the processor 52 may define the data to be evaluated as V̅(n)=[θ̅(n),Δ̅²̅θ̅(n),Δ̅²̅θ̅(n)], and θ̅(n) is the measured rotation angle for one or more time intervals in the data to be evaluated corresponding to the current time interval n (for example, a sequence or vector of θ_{H}(n), θ_{H}(n−1), or θ_{H}(n−2)), Δ̅θ̅(n) is a sequence or vector of the difference in the measured rotation angles for one or more time intervals in the data to be evaluated corresponding to the current time interval n (for example, Δθ_{H}(n), Δθ_{H}(n−1), or Δθ_{H}(n−2)), and Δ̅²̅θ̅(n) is the difference/change between the difference in the measured rotation angles for one or more time intervals in the data to be evaluated corresponding to the current time interval n and the difference in the measured rotation angles for the adjacent time interval thereof (for example, Δ²θ_{H}(n), Δ²θ_{H}(n−1), or Δ²θ_{H}(n−2)).

Since the comparison result is that the angle error is smaller or the current attitude data is closer to the previously predicted data, the rotation of the target portion still conforms to the inertial trajectory, and the inertial trajectory available for reference corresponds more to the previous attitude data. For example, assuming that the length of the time window corresponding to the data to be evaluated is 10. If all the measured rotation angles of the multiple time intervals and the changes in the measured rotation angles are selected to the data to be evaluated, then the data to be evaluated is θ̅(n)=[θ_{H}(n), θ_{H}(n−1), . . . , θ_{H}(n−9)] in V̅(n), in which Δ̅θ̅(n)=[Δθ_{H}(n), Δθ_{H}(n−1), . . . , Δθ_{H}(n−9)], and in which Δ̅²̅θ̅_̅{̅H̅}̅(n)=[Δ²θ_{H}(n), Δ²θ_{H}(n−1), . . . , Δ²θ_{H}(n−9)].

In response to the angle error between the current attitude data and the previously predicted data being between the lower error limit and the upper error limit (that is, the angle error is greater than the lower error limit, and the angle error is less than the upper error limit), the processor 52 may select the measured rotation angle and the change in the measured rotation angle of a portion of the time intervals (that is, a portion of the multiple time intervals) to the data to be evaluated (Step S530). Specifically, if the length of the time window is I, then the processor 52 may select attitude data of J time intervals, in which I is a positive integer greater than two, and J is a positive integer less than I. For example, assuming that the length of the time window corresponding to the data to be evaluated is 10. If the measured rotation angles and the changes in the measured rotation angles of the portion of the multiple time intervals are selected to the data to be evaluated, then the data to be evaluated is θ̅(n)=[θ_{H}(n), θ_{H}(n−1), 0, . . . , 0] in V̅(n), in which Δ̅θ̅(n)=[Δθ_{H}(n), 0, . . . , 0], and in which Δ̅²̅θ̅(n)=[0, 0, . . . , 0]. That is, for the measured rotation angles, only the measured rotation angles of the current time interval n and the previous time interval n−1 are selected; for the difference in the measured rotation angles, only the difference in the measured rotation angles of the current time interval n is selected; for the difference between the differences of adjacent measured rotation angles (that is, the change of the difference), the operation is to disable/not select the difference between the measured rotation angle difference of any time interval and the difference in the measured rotation angles of the adjacent time interval thereof. For unselected time interval, the processor 52 may set the corresponding value thereof in the data to be evaluated to zero or other initial values. It may be seen that compared to Step S520, which selects the attitude data of all time intervals, Step S530 selects the attitude data of fewer time intervals to the data to be evaluated.

In response to the angle error between the current attitude data and the previously predicted data being greater than the upper error limit, the processor 52 may select the measured rotation angle of the current time interval to the data to be evaluated (Step S540). Specifically, a sudden rotation of the target portion causes the angle error to increase too much (that is, to exceed the upper error limit). Therefore, the inertial data available for reference (that is, the attitude data of one or more time intervals) is less. For example, assuming that the length of the time window corresponding to the data to be evaluated is 10. If (only) the measured rotation angle of the current time interval n is selected to the data to be evaluated, then the data to be evaluated is θ̅(n)=[θ_{H}(n), 0, . . . , 0] in V̅(n), in which Δ̅θ̅(n)=[0, 0, . . . , 0], and in which Δ̅²̅θ̅(n)=[0, 0, . . . , 0]. That is, for the measured rotation angle, only the measured rotation angle of the current time interval n is selected; for the difference in the measured rotation angles, the operation is to disable/not select the difference in the measured rotation angles of any time interval (for example, the corresponding values of the sequence or vector in the data to be evaluated are all zero or initial values); for the difference between the differences of adjacent measured rotation angles, the operation is to disable/not select the difference between the measured rotation angle difference of any time interval and the difference in the measured rotation angles of the adjacent time interval thereof (for example, the corresponding values of the sequence or vector in the data to be evaluated are all zero or initial values). That is, to disable/not select all the measured rotation angles of the previous time intervals and the changes in the measured rotation angles. It may be seen that compared to Step S530, which selects the attitude data of all time intervals, Step S540 selects the attitude data of fewer time intervals to data to be evaluated.

It should be noted that in other embodiments, the error threshold is not limited to the upper error limit and the lower error limit, and the quantity of time intervals selected corresponding to each threshold may be adjusted according to actual needs.

Referring to FIG. 2, the processor 52 generates future predicted data of a future time interval by inputting the data to be evaluated to a prediction model (Step S230). Specifically, the prediction model is trained through a machine learning algorithm and learns the attitude changes of the target portion. The machine learning algorithm is, for example, multiple layer perception (MLP), convolutional neural network (CNN), long short-term memory (LSTM) network, or temporal convolutional network (TCN) (for example, Conv-TasNet), but is not limited thereto.

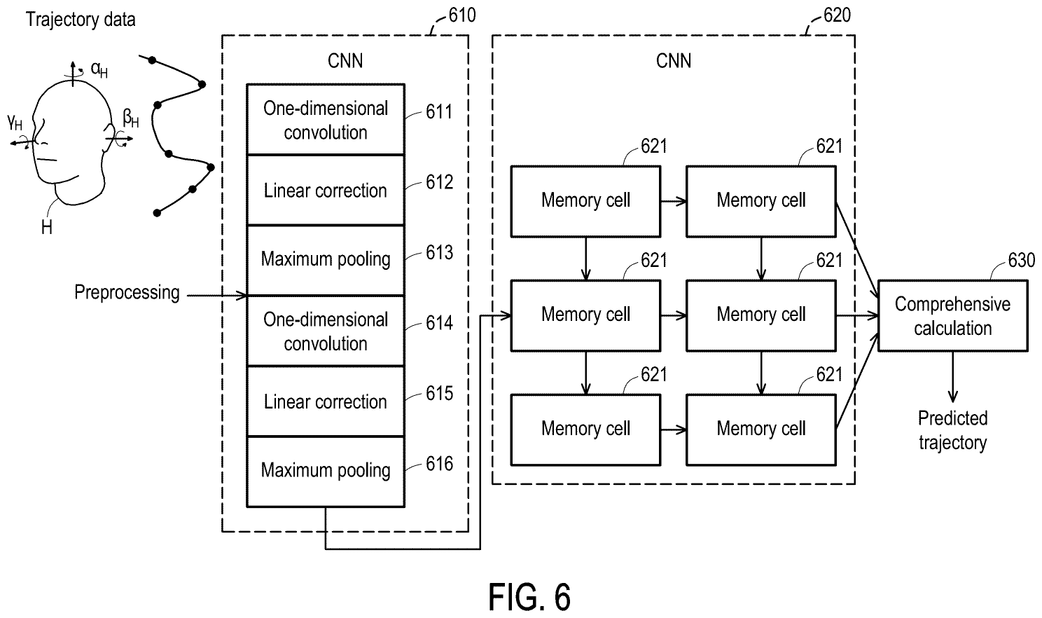

For example, FIG. 6 is a schematic diagram of a combination of a convolutional neural network (CNN) and a long short-term memory (LSTM) network according to an embodiment of the disclosure. Referring to FIG. 6, the trajectory data (that is, the attitude change of the target portion, for example, the data to be evaluated) of the target portion (taking the head as an example) may be used as the input data of the prediction model. The input data is sequentially passed through one-dimensional convolutional computation 611, linear correction 612 (for example, rectified linear unit (ReLU)), maximum pooling 613, one-dimensional convolutional computation 614, linear correction 615 (for example, ReLU), and maximum pooling 616 of CNN 610, and accordingly output the features extracted from the training samples to an LSTM network 620. The LSTM network 620 includes a plurality of memory cells 621 (also known as LSTM blocks). The LSTM network 620 may remember values for a variable length of time. There is a gate in each memory cell 612 that determines whether the input data is important enough to be remembered and whether the data may be output. A dropout operation means that in the computation of the LSTM network 620, a certain proportion of neurons is randomly discarded from the original network during each repeated computation. Then, a comprehensive calculation 630 (for example, a dense model or a fully connected layer) is performed on the multiple pieces of output data of the LSTM network 620 to generate the future predicted data (for example, the predicted trajectory of the future time interval).

The machine learning algorithm may train the prediction model to understand labeled samples (that is, attitude data (that is, attitude data for the current time interval and the previous time intervals) with labeled results (that is, attitude data for the future time interval), for example, the attitude data of the determined next time interval (that is, the future time interval) to establish a correlation between the data to be evaluated (that is, the input to the model) and the future predicted data (that is, the output of the model). For example, during the learning phase of the prediction model, the parameters of the prediction model are recursively updated by a function to minimize the error (related to the error between the output of the model and the labeled result). The method to update the parameters is, for example, the gradient descent method, but is not limited thereto. The prediction model may be a trajectory motion model with three degrees of freedom (DOF) (for example, corresponding to the three directions of rotation in FIG. 3), and is used to capture the spatial and temporal characteristics of the motion trajectory of the target portion.

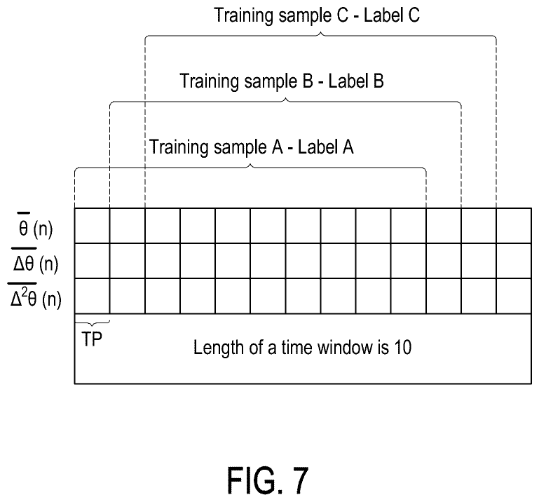

FIG. 7 is a schematic diagram of training samples according to an embodiment of the disclosure. Referring to FIG. 7, the training samples are labeled samples. Assuming that the length of the time window is 10. A training sample includes attitude data corresponding to 10 time intervals TP, and has corresponding label results (that is, label). Taking a training sample A as an example, the measured rotation angle sequence in the [θ̅(n), Δ̅θ̅(n), Δ̅²̅θ̅(n)] of the 10 time intervals TP is θ̅(n)=[θ_{H}(n), θ_{H}(n−1), . . . , θ_{H}(n−9)], the measured rotation angle difference sequence is θ̅(n)=[θ_{H}(n), θ_{H}(n−1), . . . , θ_{H}(n−9)], and the change sequence of the difference in the measured rotation angles between adjacent time intervals is Δ̅2̅θ̅(n)=[Δ²θ_{H}(n), Δ²θ_{H}(n−1), . . . , Δ²θ_{H}(n−9)]. In addition, a label A of the training sample A is the measured rotation angle θ_{H}(n+1) corresponding to future time interval n+1 (the next time interval related to the current time interval n), the difference in the measured rotation angles Δθ_{H}(n+1), and the change in the difference in the measured rotation angles between adjacent time intervals Δ²θ_{H}(n+1).

The prediction model is a model constructed after learning, and may be used to make inferences about the data to be evaluated (for example, the attitude data of one or more time intervals to be evaluated) to determine the future predicted data corresponding to the data to be evaluated.

The future predicted data includes the predicted rotation angle of the target portion in the future time interval predicted in the current time interval, for example, yaw α_{H}, pitch β_{H}, and roll γ_{H} corresponding to the three axes. In addition, the previously predicted data used in Step S220 is the predicted data corresponding to the current time interval predicted by the prediction model. That is, for the previous time interval (that is, the previous time interval that is one time interval apart from the current time interval), the data to be evaluated of the previous time interval is determined (reference may be made to the description of Step S220), and by inputting the data to be evaluated of the previous time interval into the prediction model, the future predicted data of the future time interval relative to the previous time interval (that is, the current time interval of Step S210) is generated.

Referring to FIG. 2, the processor 52 adjusts the audio characteristics of the audio signal to correspond to the predicted rotation angle of the future time interval (Step S240). Specifically, the audio signal is a signal that the computing apparatus 50 is expected to send to the audio playback device 10 and played through the audio playback device 10. The content of the audio signal may be music, speech, lecture, or broadcast, but is not limited thereto.

The audio characteristics are related to at least one of the amplitude and phase of the audio signal. In an embodiment, the audio characteristics include frequency response. The frequency response is the response of the audio signal in the frequency domain, or may be the amplitude corresponding to the audio signal at multiple frequencies. The processor 52 may measure the frequency response of the audio signal. For example, the response of the audio signal in the frequency domain is measured by inputting impulse response, but it is not limited thereto.

In an embodiment, the audio characteristics (further) include signal delay. The signal delay is the time difference of the audio signal between two channels (for example, left and right channels). For example, the cross-correlation between two-channel audio signals is calculated, and the delay amount (as the signal delay) is determined based on the peak value of the cross-correlation function.

It is worth noting that sound waves may be blocked or interfered by objects and form different propagation paths. For example, the auricle surface of an ear includes a plurality of curved surfaces. Sound waves from far away may be reflected through the pinna and into the ear canal. Alternatively, the sound waves may enter the ear canal directly. Sound waves coming from different directions also have different distribution characteristics in frequency. The frequency response may reflect the above distribution characteristics. That is, sound waves coming from different directions may correspond to different frequency responses, in which the amplitude/strength of the response at some of the frequencies may be different.

On the other hand, the propagation paths of the audio signal reaching the left and right ears directly or through reflection may be different, and the propagation times of the multiple propagation paths may also be different. That is, the time it takes for an audio signal originating from one sound source to reach the left ear and the right ear directly or through reflection may be different. Time differences in propagation/arrival times (that is, the signal delays) may affect the phase of the audio signal. Sound waves coming from different directions may also correspond to different signal delays on two channels.

In an embodiment, the processor 52 may configure corresponding spatial audio effects for multiple orientations of the target portion. In an embodiment, the processor 52 may set spatial audio effects or other audio effects through an equalizer. The parameters of the equalizer may be to have corresponding gains/powers at multiple frequencies/bands (for increasing or decreasing the response of corresponding frequencies/bands). Different parameters may be configured in different orientations and used to provide spatial audio effects or other audio effects. Taking the spatial audio effects as an example, the processor 52 may transfer a two-channel audio signal to a surround sound field with multiple virtual speakers, based on the head related transfer functions (HRTF) theory, the frequency response and/or phase from different directions are adjusted, and then the adjusted audio signal is transferred back to the two-channel stereo sound field signal.

In an embodiment, the processor 52 may adjust the frequency response of the audio signal through a first parameter of the equalizer. The first parameter corresponds to the spatial audio effect of the predicted rotation angle. The audio signal is recorded from a sound source located in the direction of the sound source. That is, the microphone is located at the reference center, and the sound source direction is the direction of the sound source relative to the reference center. The sound source direction may include a horizontal direction and/or a vertical direction. The sound source may be people, musical instruments, animals, speakers, equipment, wind or water, and is not limited thereto. For example, a person sings in front of a microphone, and the microphone records the human voice and generates an audio signal accordingly. The distance between the sound source and the reference center may be 20 cm, 50 cm, or 100 cm, and is not limited thereto. The spatial audio effect may set the direction of the sound source, so that the listener may feel that the sound originates from the sound direction. Assuming that the position of the sound source is fixed, in response to the rotation of the target portion, the direction of the sound source relative to the target portion changes (that is, the sound source direction changes). Therefore, the corrected orientation (that is, the orientation after predicting the rotation angle) corresponds to the first parameter of the equalizer. The first parameter has a corresponding gain/power at one or more frequencies/bands.

In an embodiment, the processor 52 may adjust the signal delay of the two channels of the audio signal to a correction delay. The correction delay corresponds to the spatial audio effect of the predicted rotation angle. The correction delay is the delay corresponding to the orientation of the target portion after being rotated by the predicted rotation angle. As explained above, the time it takes for sound waves from one sound source to directly reach the left ear and the right ear may be different (the difference thereof is the time delay). In spatial audio effects processing, the time delays corresponding to different orientations may be different. The processor 52 may delay at least one of the two-channel audio signals so that the signal delay of the two-channel audio signals is the same as the corrected delay (that is, the time delay corresponding to the orientation after being rotated by the predicted rotation angle). For example, the time delay of the audio signal is implemented through a buffer or a delay circuit.

In an embodiment, the future time interval includes a first sub-interval and a second sub-interval. The first sub-interval is earlier than the second sub-interval, and the second sub-interval is continued at the end of the first sub-interval. Assuming that the length of the time interval is 30 milliseconds, then the lengths of the first sub-interval and the second sub-interval are both 15 milliseconds. However, the length of the sub-interval may still be adjusted according to actual needs. In order to avoid the target portion rotating too fast and the instantaneous sound field changes causing discomfort to the auditory experience, each time interval may be divided into multiple (for example, a positive integer greater than one) sub-intervals of predicted rotation angle \hat{θ}ₐ(n+1) before adjusting the audio signal.

Taking two sub-intervals as an example, the processor 52 may determine that the new predicted rotation angle corresponding to the first sub-interval is the average of the predicted rotation angle of the current time interval and the predicted rotation angle of the future time interval, and may determine that the new predicted rotation angle corresponding to the second sub-interval is the predicted rotation angle of the future time interval:

$${\hat{θ}}_{a} ( n + 1 ) = \{ \begin{matrix}\frac{1}{2} \times ( ( n ) + ( n + 1 ) ) , & first sub - interval \\ ( n + 1 ) , & second sub - interval\end{matrix} \qquad ( 7 )$$

\hat{θ}ₐ(n+1) is the new predicted rotation angle of the future time interval n+1, [symbol] (n) is the predicted rotation angle of the current time interval n (that is, the predicted rotation angle of the current time interval n predicted in the previous time interval n−1), and [symbol] (n+1) is the predicted rotation angle of the future time interval n+1 (that is, the predicted rotation angle generated by the prediction model in Step S230). The first sub-interval is a transition zone, which is formed by the predicted rotation angle [symbol] (n) of the target portion predicted in the previous time interval n−1 and the predicted rotation angle [symbol] (n+1) of the target portion estimated in the current time interval n (for example, taking the average value or weighted computation value of other weights). The second sub-interval is the rotation angle of the main target portion, and directly corresponds to the predicted rotation angle [symbol] (n+1) of the target portion of the future time interval n+1 generated by the prediction module. In other words, for the adjustment of the audio signal in the first sub-interval, the new predicted rotation angle in the first sub-interval is adopted to make the adjustment accordingly; for the adjustment of the audio signal in the second sub-interval, the new predicted rotation angle in the second sub-interval is adopted to make the adjustment accordingly.

It should be noted that in other embodiments, the future time interval may be divided into more sub-intervals. The proportion of the predicted rotation angle [symbol] (n) to the predicted rotation angle [symbol] (n+1) in the new predicted rotation angle of the sub-intervals may be different. For example, the proportion of the predicted rotation angle [symbol] (n) in the new predicted rotation angle is higher for the sub-interval closer to the current time interval, and the proportion of the predicted rotation angle [symbol] (n) in the new predicted rotation angle is lower for the sub-interval farther from the current time interval.

In summary, in the adjustment method of the audio signal and the computing apparatus for the audio signal adjustment according to the embodiments of the disclosure, the previously predicted data predicted in the previous time interval and the current attitude data measured in the current time interval are used to evaluate and select the appropriate attitude data as the data to be evaluated for the prediction model, the future predicted data corresponding to the data to be evaluated is generated through the prediction model, and the audio characteristics of the audio signal are adjusted accordingly. In this way, spatial audio effects with less delay time can be obtained. The data to be evaluated may be dynamically and immediately adjusted according to the amount of change in the rotation of the target portion. In addition, before adjusting the audio signal, the time interval is divided into multiple sub-intervals of new predicted rotation angles, which can avoid the uncomfortable listening experience caused by instantaneous sound field changes.

Although the disclosure has been disclosed above through embodiments, the embodiments are not intended to limit the disclosure. Persons with ordinary knowledge in the relevant technical field may make some changes and modifications without departing from the spirit and scope of the disclosure. Therefore, the protection scope of the disclosure shall be determined by the appended claims.

What is claimed is:

1. An adjustment method of an audio signal, comprising:
measuring current attitude data of a current time interval, wherein the current attitude data comprises a measured rotation angle of a target portion in the current time interval;
determining data to be evaluated based on an angle error between the current attitude data and previously predicted data, wherein the previously predicted data comprises a predicted rotation angle of the target portion in the current time interval predicted in a previous time interval, the angle error is an error between the measured rotation angle and the predicted rotation angle, and a comparison result of the angle error with an error threshold is used to select attitude data of at least one of a plurality of time intervals to the data to be evaluated;
generating a future predicted data of a future time interval by inputting the data to be evaluated into a prediction model, wherein the prediction model is trained through a machine learning algorithm and learns attitude changes of the target portion, the future predicted data comprises the predicted rotation angle of the target portion in the future time interval predicted in the current time interval, and the previously predicted data is predicted data corresponding to the current time interval predicted by the prediction model; and
adjusting an audio characteristic of an audio signal to the predicted rotation angle corresponding to the future time interval, wherein the audio characteristic is related to at least one of amplitude and phase of the audio signal.

2. The adjustment method of the audio signal according to claim 1, wherein the closer the comparison result corresponds to selecting the attitude data from more of the time intervals, the farther the comparison result corresponds to selecting the attitude data from less of the time intervals, and the attitude data of the time intervals comprises the measured rotation angle of the target portion in the time intervals and a change in the measured rotation angle.

3. The adjustment method of the audio signal according to claim 1, wherein the error threshold comprises a lower error limit, and determining the data to be evaluated based on the angle error between the current attitude data and the previously predicted data comprises:
comparing the angle error with the lower error limit, wherein in response to the angle error being less than the lower error limit, the measured rotation angle of all of the time intervals and the change in the measured rotation angle are selected to the data to be evaluated.

4. The adjustment method of the audio signal according to claim 1, wherein the error threshold comprises an upper error limit and a lower error limit, and determining the data to be evaluated based on the angle error between the current attitude data and the previously predicted data comprises:
comparing the angle error with the upper error limit, and comparing the angle error with the lower error limit, wherein in response to the angle error being between the lower error limit and the upper error limit, the measured rotation angle and the change in the measured rotation angle of a portion of the time intervals are selected to the data to be evaluated.

5. The adjustment method of the audio signal according to claim 1, wherein the error threshold comprises an upper error limit, and determining the data to be evaluated based on the angle error between the current attitude data and the previously predicted data comprises:
comparing the angle error with the upper error limit, wherein in response to the angle error being greater than the upper error limit, the measured rotation angle of the current time interval is selected to the data to be evaluated.

6. The adjustment method of the audio signal according to claim 1, wherein the change in the measured rotation angle comprises a difference in the measured rotation angle between a first time interval and a second time interval in the time intervals and a change of the difference.

7. The adjustment method of the audio signal according to claim 1, wherein the machine learning algorithm comprises a convolutional neural network (CNN) and a long short-term memory (LSTM) network.

8. The adjustment method of the audio signal according to claim 1, wherein the future time interval comprises a first sub-interval and a second sub-interval, the first sub-interval is earlier than the second sub-interval, and the adjustment method further comprises:
determining a new predicted rotation angle corresponding to the first sub-interval to be an average of the predicted rotation angle of the current time interval and the predicted rotation angle of the future time interval; and
determining a new predicted rotation angle corresponding to the second sub-interval to be the predicted rotation angle of the future time interval.

9. The adjustment method of the audio signal according to claim 1, wherein the audio characteristic comprises a frequency response and a signal delay, the frequency response is the amplitude corresponding to the audio signal at multiple frequencies, the signal delay is a time difference of the audio signal between two channels, and adjusting the audio characteristic of the audio signal to the predicted rotation angle corresponding to the future time interval comprises:
adjusting the frequency response of the audio signal through a first parameter of an equalizer, wherein the first parameter corresponds to spatial audio effect of the predicted rotation angle; and
adjusting the signal delay of the two channels of the audio signal is adjusted to a correction delay, wherein the correction delay corresponds to the spatial audio effect of the predicted rotation angle.

10. A computing apparatus for audio signal adjustment, comprising:
a storage device configured to store a program code; and
a processor coupled to the storage device and configured to load the program code to perform:
measuring current attitude data of a current time interval, wherein the current attitude data comprises a measured rotation angle of a target portion in the current time interval;
determining data to be evaluated based on an angle error between the current attitude data and previously predicted data, wherein the previously predicted data comprises a predicted rotation angle of the target portion in the current time interval predicted in a previous time interval, the angle error is an error between the measured rotation angle and the predicted rotation angle, and a comparison result of the angle error with an error threshold is used to select attitude data of at least one of a plurality of time intervals to the data to be evaluated;
generating a future predicted data of a future time interval by inputting the data to be evaluated into a prediction model, wherein the prediction model is trained through a machine learning algorithm and learns attitude changes of the target portion, the future predicted data comprises the predicted rotation angle of the target portion in the future time interval predicted in the current time interval, and the previously predicted data is predicted data corresponding to the current time interval predicted by the prediction model; and
adjusting an audio characteristic of an audio signal to the predicted rotation angle corresponding to the future time interval, wherein the audio characteristic is related to at least one of amplitude and phase of the audio signal.

11. The computing apparatus for audio signal adjustment according to claim 10, wherein the closer the comparison result corresponds to selecting the attitude data from more of the time intervals, the farther the comparison result corresponds to selecting the attitude data from less of the time intervals, and the attitude data of the time intervals comprises the measured rotation angle of the target portion in the time intervals and a change in the measured rotation angle.

12. The computing apparatus for audio signal adjustment according to claim 10, wherein the error threshold comprises an upper error limit and a lower error limit, and the processor is further configured to:
compare the angle error with the lower error limit, wherein in response to the angle error being less than the lower error limit, the measured rotation angle of all of the time intervals and the change in the measured rotation angle are selected to the data to be evaluated;
compare the angle error with the upper error limit, and comparing the angle error with the lower error limit, wherein in response to the angle error being between the lower error limit and the upper error limit, the measured rotation angle and the change in the measured rotation angle of a portion of the time intervals are selected to the data to be evaluated; and
compare the angle error with the upper error limit, wherein in response to the angle error being greater than the upper error limit, the measured rotation angle of the current time interval is selected to the data to be evaluated.

13. The computing apparatus for audio signal adjustment according to claim 10, wherein the change in the measured rotation angle comprises a difference in the measured rotation angle between a first time interval and a second time interval in the time intervals and a change of the difference.

14. The computing apparatus for audio signal adjustment according to claim 10, wherein the machine learning algorithm comprises a convolutional neural network (CNN) and a long short-term memory (LSTM) network.

15. The computing apparatus for audio signal adjustment according to claim 10, wherein the future time interval comprises a first sub-interval and a second sub-interval, the first sub-interval is earlier than the second sub-interval, and the processor is further configured to:
determine a new predicted rotation angle corresponding to the first sub-interval to be an average of the predicted rotation angle of the current time interval and the predicted rotation angle of the future time interval; and
determine a new predicted rotation angle corresponding to the second sub-interval to be the predicted rotation angle of the future time interval.

16. The computing apparatus for audio signal adjustment according to claim 10, wherein the audio characteristic comprises a frequency response and a signal delay, the frequency response is the amplitude corresponding to the audio signal at multiple frequencies, the signal delay is a time difference of the audio signal between two channels, and the processor is further configured to:
adjust the frequency response of the audio signal through a first parameter of an equalizer, wherein the first parameter corresponds to spatial audio effect of the predicted rotation angle; and
adjust the signal delay of the two channels of the audio signal is adjusted to a correction delay, wherein the correction delay corresponds to the spatial audio effect of the predicted rotation angle.
